(19) United States
(12) Patent Application Publication
(10) Pub. No.: US 2009/0065171 A1
(43) Pub. Date: Mar. 12, 2009

(54) Cooling system for a motor vehicle

(76) Inventors: Robert Harry McPherson, Queensland (AU); Bruce Phelps Hollenbeck, Orefield, PA (US)

Correspondence Address: VOLVO TECHNOLOGY OF AMERICA, CORPORATE PATENTS, 7825 NATIONAL SERVICE ROAD, MAIL STOP, AP1/3-41, GREENSBORO, NC, 27409, US

(21) Appl. No.: 11/919,893

(22) PCT Filed: May 5, 2005
(86) PCT No.: PCT/US2005/015520

§ 371 Date: Jan. 7, 2008

(51) Int. Cl. B60H 1/00

(52) U.S. Cl. 165/41

(57) ABSTRACT

A cooling system (100) for a motor vehicle includes a snorkel (102) positioned on the vehicle for collecting air while the vehicle is moving. An air duct (104) is coupled with the snorkel (102) on a first end and has an exhaust at a second end. A heat exchanger (106) is coupled with a component such as a transmission (108) of the vehicle and positioned within the duct (104) for cooling the component (108) with the air passing through the duct (104).

### BACKGROUND OF THE INVENTION

1. Field of the Invention

The present invention relates generally to systems and methods for cooling components in a motor vehicle, such as a truck. More particularly, the present invention relates to a heat exchanger for a truck transmission.

2. Description of the Related Art

It is well known that high horsepower vehicle engines generate high torque loads through the vehicle's transmission. High torque generates high heat loads to the point where cooling of manual gearbox transmissions is necessary. transmission coolers are often provided by the vehicle manufacturer, but specified by the transmission manufacturer.

Emissions requirements have placed an increasing demand on vehicle cooling systems, especially in commercial vehicles such as heavy trucks. Cooling module size and cost have increased as technology has been added to improve engine efficiency. The heating load has been so great that cooling for devices such as transmissions, retarders, and air condition systems can no longer be mounted on the engine cooling module.

Cooling Systems technology has not kept pace with the demands placed upon it. The result is that radiator size is increasing. This is affecting the styling of the vehicle and results in a heavy volume of product changes

In order to overcome deficiencies, manufacturers have mounted small heat exchangers in a convenient location within the engine compartment. However, air flow may not be sufficient for a secondary heat exchanger, the heat exchanger will not be efficient. For example, one solution involves installing a small air-oil heat exchanger on the vehicle, which circulates transmission lubrication oil via a pump in the transmission. It is difficult, however, to ensure good air flow across the heat exchanger to maximize its efficiency.

The heat exchanger can be mounted on the engine cooling module at the front of the vehicle, so that the engine cooling fan is used to force air across it. In such configuration, the heat load is increased on an already overworked engine cooling module. Cooling modules mounted at the front of the vehicle also require long coolant lines from the manual gearbox to the cooling module. Electric or hydraulic fans are typically employed to increase the efficiency. Adding such fans can be complex and expensive. Typically, the cooling module is left exposed to whatever air flow is available, which is usually turbulent and without direction, resulting in a very inefficient system.

Thus, there is a need for new and improved cooling systems and methods of cooling secondary components, such as a transmission, that will not increase the cooling load on the vehicle engine.

### SUMMARY OF THE INVENTION

According to an embodiment of the present invention, a cooling system for a motor vehicle includes a snorkel positioned on the vehicle for collecting air while the vehicle is moving. An air duct is coupled with the snorkel on a first end and has an exhaust at a second end. A heat exchanger is coupled with a component of the vehicle and positioned within the duct for cooling the component with the air passing through the duct.

The air is preferably ram injected to the heat exchanger and exhausted out the rear of the vehicle. The heat exchanger is preferably position in the duct, close to the component being cooled.

Further applications and advantages of various embodiments of the present invention are discussed below with reference to the drawing figures.

### BRIEF DESCRIPTION OF THE DRAWINGS

FIG. 1 is a diagram of a transmission cooling system using ram air injection according to an embodiment of the present invention.

FIGS. 2A-B are schematic diagrams of an exemplary heat exchanger and snorkel for the cooling system according to an embodiment of the present invention.

FIG. 3 is a plan view of a truck having the cooling system according to an embodiment of the present invention.

### DETAILED DESCRIPTION OF THE PREFERRED EMBODIMENTS

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

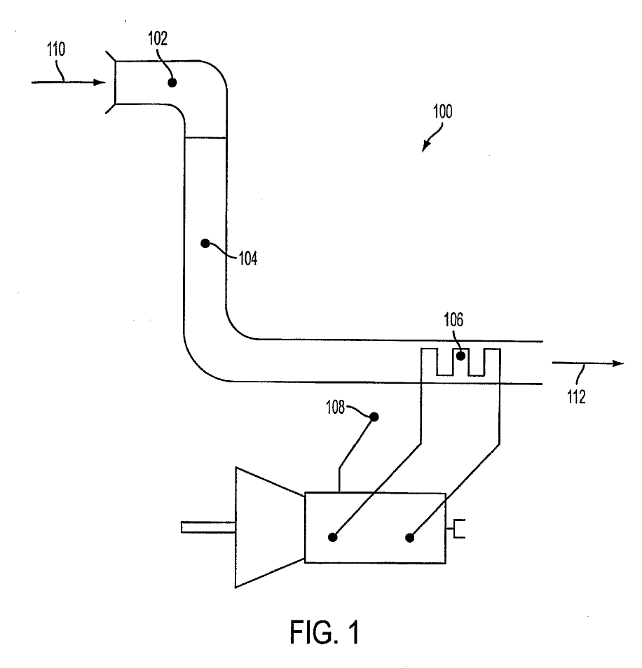

According to the present invention a method is provided to remove some of the cooling load from the engine. A transmission cooling system for a truck is depicted in FIG. 1. The system 100 includes a snorkel 102, a duct 104, and a heat exchanger 106. Ram air 110 (i.e., 55-75 mph) is collected by the snorkel 102 and is routed through the duct 104 to the transmission heat exchanger 106 located in the duct 104. Hot oil from the transmission 108 is circulated from the transmission 108 to the heat exchanger 106. Heat from the transmission 108 is transferred to the ram air flowing through the duct 104 and exhausted 112 behind the truck.

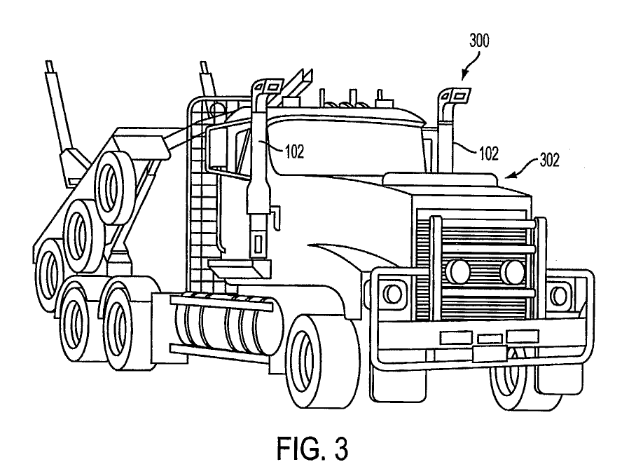

In a preferred embodiment, the snorkel intake 102 can be located in the vicinity of the truck hood, in front of the windshield. For example, referring to FIG. 3, the snorkel 102 can be located one or both sides of the cab 302 of a truck 300. The heat exchanger 106 can be located in the unused space, such as under the truck cab. The duct 104 preferably passes under the cab and exhausts the air behind the truck.

The heat exchanger 106 is preferably a high efficiency coil or tube type heat exchanger to maximize heat transfer from the transmission oil. One skilled in the art will understand that the cross sectional area of the duct can be selected in order to provide for a maximum heat transfer given space requirements under a vehicle.

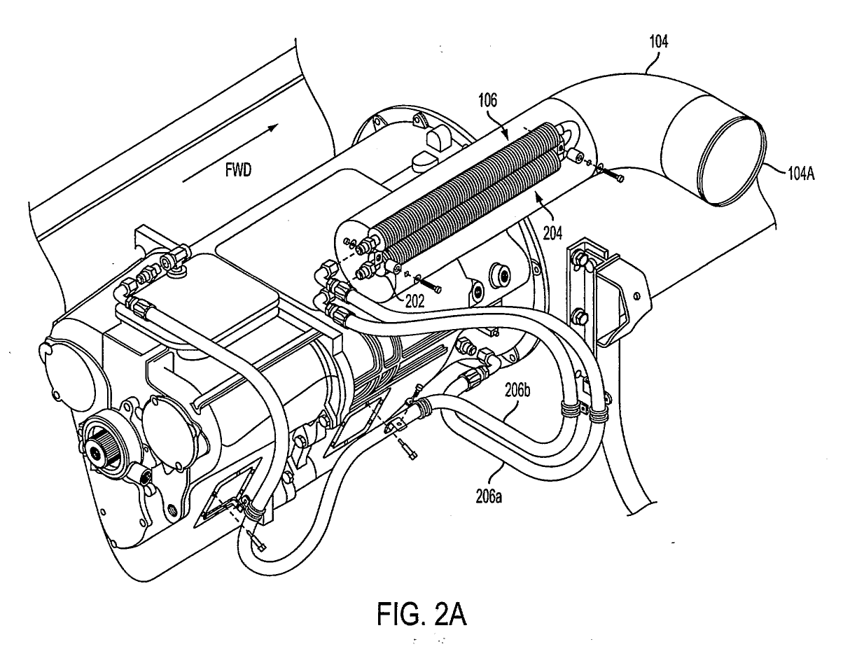

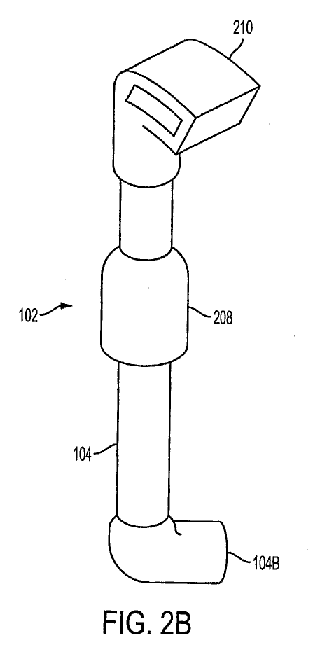

Referring to FIGS. 2A-B, a heat exchanger 106 includes a pipe 202 having a single turn, the pipe 202 having fins 204 for exchanging heat with the air passing through the duct 104. Hoses 206a, 206b circulate the fluid to be cooled from the engine component (e.g., transmission oil). The snorkel 102 includes an intake structure 210 and may include a throttle or muffler 208. As shown, the duct 104 are connected at 104A and 104B between the sections respectively in FIGS. 2A and 2B.

In one embodiment, the duct is preferably approximately 4 inches in diameter.

The present system is described in terms of a transmission cooling system, but other cooling systems are contemplated. By providing for a separate, ram injected air supply for the heat exchangers, secondary systems can be cooled without adding load to the engine coolant system.

Thus, a number of preferred embodiments have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention.

We claim:

1. A cooling system for a motor vehicle, said cooling system comprising:
a snorkel positioned on the vehicle for collecting air while the vehicle is moving;
an air duct coupled with said snorkel on a first end and providing an exhaust at a second end; and
a heat exchanger coupled with a component of said vehicle and positioned within said duct for using the air passing through the duct to cool said component.

2. The cooling system as recited in claim 1, wherein said heat exchanger is coupled with a transmission of said vehicle and cools transmission fluid of said transmission.

3. The cooling system as recited in claim 2, further comprising an oil pump for pumping oil from said transmission through said heat exchanger.

4. The cooling system as recited in claim 1, wherein said snorkel is position in a vicinity of a hood of said vehicle and approximately in front of a front windshield of said vehicle.

5. The cooling system as recited in claim 1, wherein said vehicle is a heavy truck.

6. The cooling system as recited in claim 1, wherein heat exchanger is positioned in a section of said duct under a cabin of said vehicle.

7. The cooling system as recited in claim 1, wherein the air collected by said snorkel is ram injected.

8. The cooling system as recited in claim 1, wherein said heat exchanger comprises a plurality of tubes for transferring heat from fluid in the tubes to the air.

9. A cooling system for a motor vehicle, said cooling system comprising:
an intake means for collecting air while said vehicle is moving;
a heat exchanger means for cooling a component of said vehicle with said air; and
an air duct means for transferring said air to said heat exchanger means.

10. The cooling system as recited in claim 9, wherein said heat exchanger means is coupled with a transmission of said vehicle and cools transmission fluid of said transmission.

11. The cooling system as recited in claim 10, further comprising a pump means for pumping oil from said transmission through said heat exchanger means.

12. The cooling system as recited in claim 9, wherein said intake means is position in a vicinity of a hood of said vehicle and approximately in front of a front windshield of said vehicle.

13. The cooling system as recited in claim 9, wherein said vehicle is a heavy truck

14. The cooling system as recited in claim 9, wherein heat exchanger means is positioned in a section of said duct means under a cabin of said vehicle.

15. The cooling system as recited in claim 9, wherein the intake means ram injects air into the duct means.
